(19) United States
(12) Patent Application Publication
(10) Pub. No.: US 2014/0251484 A1
(43) Pub. Date: Sep. 11, 2014

(54) SANITARY HOSE WITH AN INNER HOSE AND A SHEATHING

(71) Applicant: Neoperl GmbH, Mullheim (DE)

(72) Inventor: Werner Kury, Mullheim (DE)

(73) Assignee: NEOPERL GMBH, Mullheim (DE)

(21) Appl. No.: 14/197,842

(22) Filed: Mar. 5, 2014

(30) Foreign Application Priority Data
Mar. 7, 2013 (DE) 102013003831.6

(51) Int. Cl. F16L 11/02

(52) U.S. Cl. CPC F16L 11/02
USPC 138/124

(57) ABSTRACT

A sanitary hose (1) has an inner hose (2) and a braided sheathing (4), made of mutually intersecting braiding parts (3), which encloses the inner hose (2). At least one of the braiding parts (3) or preferably all braiding parts (3) are configured here as single-part ribbons which thus replace multi-part braiding parts of such type formed by individual closely fitting wires or filaments. Here, a width of this ribbon is greater than its thickness and a wide side of the braiding parts (3) faces toward the inner hose (2). The peripheries (3a) of these ribbon-shaped braiding parts (3) have a tapered cross section, such that these peripheries (3a) extend tapering toward the outside and as a result permit an improved adaptation of intersecting braiding parts (3) even at the intersecting points (5).

INCORPORATION BY REFERENCE

The following documents are incorporated herein by reference as if fully set forth: German Patent Application No. DE 102013003831.6, filed Mar. 7, 2013.

### BACKGROUND

The invention relates to a sanitary hose with an inner hose, in particular made of plastic, and with a braided sheathing, made of mutually intersecting braiding parts, which encases the inner hose.

A sanitary hose of this type is known, for example, from EP 1 880 812 B1. Furthermore, a water hose, in which, as in the previously known sanitary hose, the braiding parts are configured as groups of threads or wires running alongside one another, is disclosed in DE 197 27 142 A1, wherein these groups are in each case interlaced with one another and, accordingly, mutually intersect in the use position.

A sheathing of this type braided from wires or threads often has gaps, in particular at the intersecting points, which are formed by the cross-sectional shape of the individual peripheral wires or filaments, such that it is possible for light and moisture to enter and for the inner hose to be affected by UV light. Furthermore, algae may grow in the interior of the inner hose in the event of such entering of light.

Furthermore, in the event of bending of a hose having sheathing with the aforementioned insufficient covering, this hose may partially displace the sheathing in the bend region and may even protrude from said sheathing.

### SUMMARY

It is, therefore, the object to provide a sanitary hose of the type mentioned at the outset, in which the degree of covering of the braided sheathing is improved, in particular including in the region of mutually intersecting braiding parts.

This object is achieved by a sanitary hose having one or features of the invention.

In the sanitary hose according to the invention with a sheathing made of mutually intersecting braiding parts, it is provided that at least one of the braiding parts is configured as a single-part ribbon, a width of which is greater than its thickness and a wide side of which faces toward the inner hose.

This braiding part thus does not have any individual wires or plastic filaments, and as a result this braiding part on its own already has greater stability than one made from individual wires and individual filaments. Furthermore, an accordingly strong and stable braiding having good covering in the peripheral regions of the braiding parts is possible.

It is particularly expedient here for all braiding parts, which in the use position are mutually interlaced and mutually intersecting, to be configured as ribbons or single-part ribbons. Such ribbons may be braided so as to be mutually contacting also in the intersecting region and allow here a dense configuration of the sheathing and thus a good covering.

An embodiment of the invention of very considerable and advantageous significance may be one in which the cross-sectional thickness of the ribbon forming a braiding part decreases at at least one of its peripheries or preferably at both peripheries and in which the peripheries of the ribbon taper in a stepped or continuous manner as seen in the cross-sectional view. Due to this, transversely running ribbons especially can adapt to these cross-sectional decreases at the intersecting point at which they change their level due to the braiding process and first run over such a ribbon and subsequently under such a ribbon, and result in a practically continuous covering at the intersecting points, as well. The configuration according to the invention of the braiding parts as single-part ribbons is thus used to give these ribbons a cross section which considerably improves the close fit of mutually intersecting ribbons also at the peripheral regions and thus increases the tightness of the sheathing.

It is favorable here for every tapering at the two peripheries of a ribbon to be symmetrical to the longitudinal center which is located between the wide sides of the ribbon and/or to the center running between the peripheries. In this manner, matching taperings, which are however oriented towards opposite sides and which have the described favorable effect on the tightness of the sheathing in the case of mutually intersecting ribbons, result at both peripheries of the ribbon, wherein the further advantage of being able to use the ribbons in the same way in any discretionary orientation and possibly even when reversed is made possible.

The end of the cross section of the tapering of the periphery of at least one longitudinal side or of both longitudinal sides of the ribbon may be pointed or rounded. Here, a pointed cross-sectional shape can be particularly well adapted and fitted closely to intersecting ribbons, whereas an at least slightly rounded embodiment is easier to handle and, especially also in the case of an embodiment made of metal, constitutes a lower risk of injury.

The cross section of the tapering at the periphery of the ribbon may be delimited in a linear manner or, at least on one side, in a convex and/or concave shape. Here, this shape can be selected according to how the mutually intersecting ribbons bend and deform at such an intersecting point and can be adapted to the corresponding periphery.

Depending on the cross-sectional thickness of the ribbons according to the invention, the angle which is enclosed by the faces delimiting the tapering may be calculated differently. It is expedient for it to be an acute angle, in particular a right angle or a relatively smaller angle of 90° to 20°, in particular of 70° to 40°, preferably of 60° to 50°. Oblique faces, to which mutually intersecting ribbons or braiding parts can readily adapt and closely fit during the formation of the braided sheathing, thus result at the peripheries in the region where they taper, such that a dense covering is created.

Here, the cross-sectional thickness of the ribbon between its taperings can be approximately one tenth of a millimeter to two fifths of a millimeter, preferably one fifth of a millimeter to one quarter of a millimeter, and the total width can be one and one quarter millimeters to two millimeters or more, or an intermediate value. The choice of the total width and also of the cross-sectional thickness may depend, for example, on the diameter of the inner hose. The larger the latter, the larger the mentioned dimensions may be selected to be.

Here, the relationship of the width of the ribbon to its cross-sectional thickness may also be selected in a variable manner. For example, the width of the ribbon may be five times to twenty times, seven times to ten times, two times to eight times, or four times to six times as large as its thickness. Intermediate values are possible here, too.

The wide sides of the ribbon may be linear or undulated between its peripheries, as seen in the cross-sectional view, and the cross section of the single-part ribbon may be formed in particular of neighboring alternately thicker and thinner regions. The ribbon is correspondingly flexible also in adapting to the rounding of the inner hose to be braided, it being possible in the cross section for one of the wide sides to be configured in a selected manner and the other in a linear manner. However, the best flexibility in the transverse direction to the longitudinal extent is achieved when both wide sides are undulated and the crests of the undulations and the troughs of the undulations are located at matching points, such that—as already mentioned—thicker and thinner regions of the cross section are distributed in an alternating manner across the width of the ribbon.

The braiding parts of the sheathing may be formed of metal and/or plastic, and all braiding parts of a sheathing may be formed of the same material, or a mix of braiding parts made of metal and those made of plastic may be provided for the formation of the sheathing.

In particular when combining individual or a plurality of the afore-described features and measures, a sanitary hose with an inner hose and a braided sheathing is achieved in which also the regions where two mutually intersecting braiding parts directly form an angle with one another can be largely tight, in particular when, commencing from a moderate or relatively large thickness, the peripheral regions of the ribbons forming the braiding parts taper such that transversely arranged regions of intersecting braiding parts can bear on the oblique faces which form the tapering and in this manner improve the covering.

### BRIEF DESCRIPTION OF THE SEVERAL VIEWS OF THE DRAWINGS

In the following, an exemplary embodiment of the invention is explained in more detail by means of the drawing in which, partly in a schematic illustration:

FIG. 1 shows a view a sanitary hose according to the prior art, and

FIG. 2 shows a partial longitudinal section of a sanitary hose according to the prior art, wherein mutually intersecting braiding parts are formed of individual wires or filaments which lie alongside one another in groups, and such groups of wires or filaments are arranged so as to be mutually intersecting, in an analogous manner to EP 1 880 812 B1,

FIG. 3 shows a view of a sanitary hose according to the invention, and

FIG. 4 shows a partial longitudinal section of said sanitary hose according to the invention, wherein the braided sheathing is formed by mutually intersecting braiding parts which are configured as single-part ribbons, the width of which is greater than their cross-sectional thickness, wherein the cross-sectional thickness of the ribbons at the peripheries which face one another is configured so as to be continuously decreasing and tapered.

### DETAILED DESCRIPTION OF THE PREFERRED EMBODIMENTS

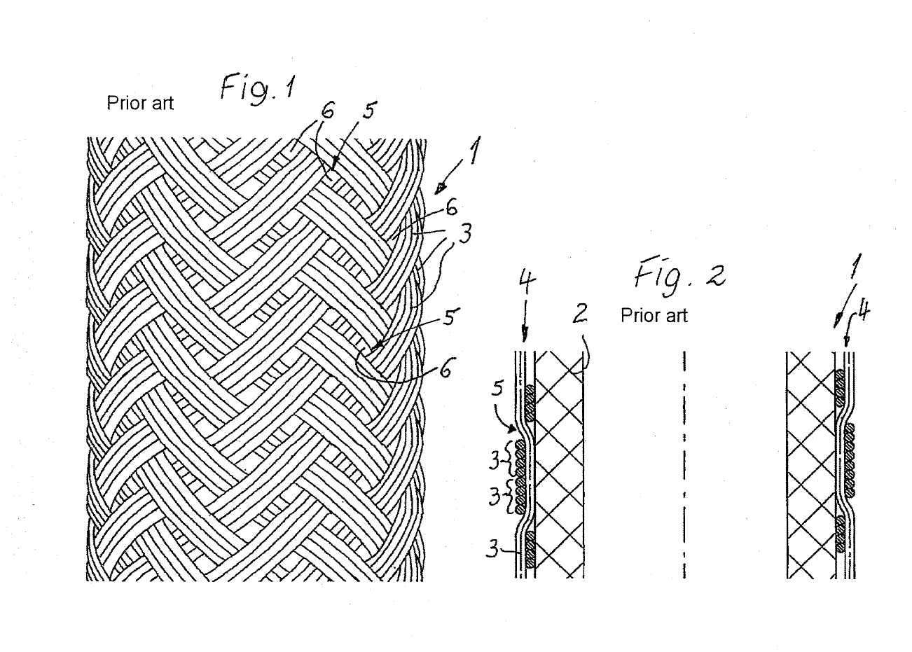

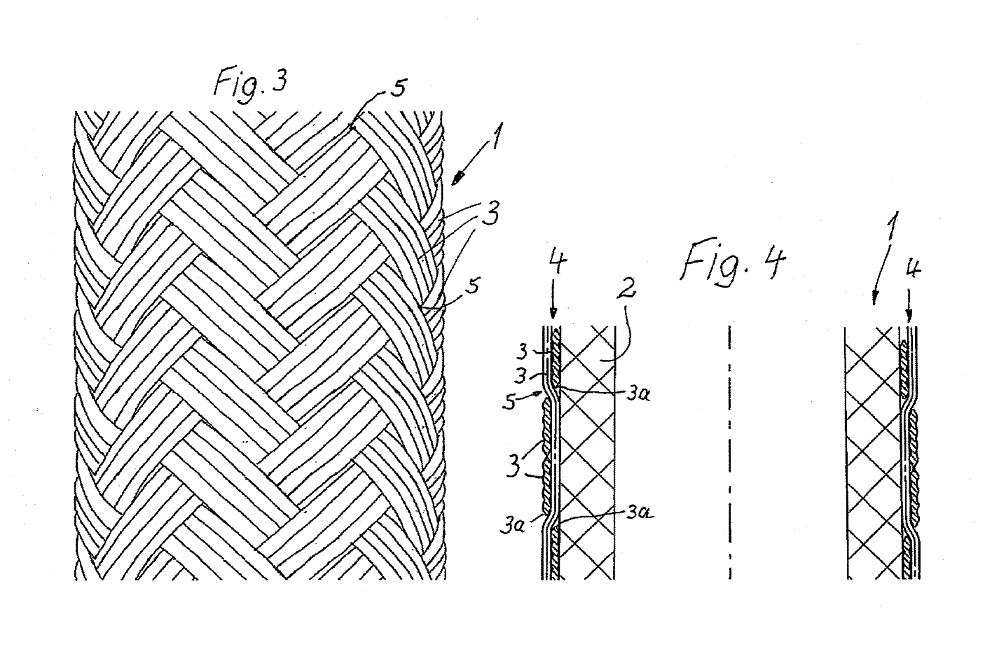

One piece of an external view of a sanitary hose designated 1 overall is in each case illustrated in FIGS. 1 and 3, wherein FIG. 1 shows a sanitary hose according to the prior art and FIG. 3 shows an exemplary embodiment according to the invention.

The sanitary hose 1 is formed here, in each case in an analogous manner to EP 1 880 812 B1, of an inner hose 2 and a sheathing 4 which encloses the inner hose 2 and is braided from mutually intersecting braiding parts 3.

Both in the prior art and in the case of the invention, the braiding is constructed here according to an identical principle in which braiding parts 3 in each case mutually intersect, wherein one braiding part always crosses over or under two intersecting braiding parts but, in this process, two braiding parts which intersect and run transversely to one braiding part alternately run over and under said braiding part, as is known in the prior art and, for example, also from EP 1 880 812 B1.

According to FIG. 2, it is provided in the prior art that the individual braiding parts 3 are formed by groups of four individual wires or filaments which are arranged so as to be parallel to one another and to contact one another, so that, on account of the cross sections of these mutually intersecting wires or filaments, relatively large gaps 6 invariably remain vacant at the intersecting points 5, even when the braiding is formed and applied under great force.

In the exemplary embodiment according to the invention according to FIGS. 3 and 4, these relatively large gaps 6 at the intersecting points 5 are largely avoided by a plurality of measures which are identifiable mainly in FIG. 4.

It is possible to see in FIG. 4 that at least one of the braiding parts 3 is configured as a single-part ribbon, the width of which is greater than its thickness and the wide side of which faces toward the inner hose 2.

At the same time, it can be seen in FIG. 4 that at least the braiding parts 3, which are identifiable here in cross section, are all configured as ribbons, even those braiding parts 3 which fit closely with one longitudinal periphery in this sectional region and which are in direct contact with one another in approximately the central region of FIG. 4. It is expedient here for the braiding parts 3, too, which run transversely and are identifiable in a side view in FIG. 4, to be configured as ribbons of this type having a matching cross section.

Whereas the peripheries of the braiding parts 3 in the arrangement according to FIG. 2 corresponding to the prior art are in each case formed by individual wires or filaments with a corresponding cross section and thus have a relatively abrupt periphery, it is provided in the exemplary embodiment according to FIG. 4 that the cross-sectional thickness of the ribbons forming a braiding part 3 decreases at the peripheries 3a and the peripheries 3a of the ribbon, when seen in the cross-sectional view, in each case taper continuously from the greatest cross-sectional thickness. It is correspondingly easy for a braiding part 3 configured as a ribbon to nestle against these tapered peripheries 3a, as can easily be seen in FIG. 4 at the intersecting points 5. Any gap 6 which might potentially be created there is correspondingly smaller, or, rather, such a gap 6 can hardly be created since the braiding parts 3 come to lie more closely alongside one another with their peripheries 3a in those regions which run parallel to one another than is possible with individual wires or filaments on account of the mutually intersecting wires or filaments according to FIG. 2.

In the exemplary embodiment according to FIG. 4, every tapering at the peripheries 3a of a ribbon forming a braiding part 3 is arranged here symmetrically to the longitudinal center, which is located between the wide sides of the ribbon, and also to the center, running between the peripheries 3a, of said ribbon.

Although the oblique faces which form the tapering of the peripheries 3a also run asymmetrically to the longitudinal center which is arranged between the widths of the ribbon, the symmetrical configuration is the easiest to handle in the context of the entire braiding of the sheathing 4.

According to FIG. 4, the end of the cross section of the tapering of the periphery 3a is almost pointed, but preferably also somewhat rounded in order to guard against the risk of injury during handling, in particular when the braiding parts 3 are made of metal or of a tough plastic.

Here, according to FIG. 4, the cross section of the tapering at the periphery 3a of the ribbons is linear. The angle which is enclosed by the faces delimiting the tapering is an acute angle, which favors the course of the intersecting braiding parts 3 or ribbons, respectively.

The exemplary embodiment here shows that the width of the respective ribbon is much larger than the cross-sectional thickness, thus reproducing the prior art to the extent that, according to their numbers, the individual parallel wires or filaments which are in mutual contact likewise have a correspondingly larger width than thickness. Four filaments or wires fitting closely result, for example, in a width which is four times as large as the thickness.

In the case of the ribbons identifiable in FIG. 4, the width in relation to the cross-sectional thickness is, in contrast, even somewhat larger, or the thickness in relation to the width is smaller, respectively.

The wide sides of the ribbons in the exemplary embodiment according to FIG. 4 are undulated between its peripheries 3a, when seen in the cross-sectional view, specifically so on both sides of the respective ribbon, wherein alternately thick and thinner regions are arranged alongside one another. An undulation on one side of the ribbon is mirrored by a like undulation on the other side, and the troughs of the two sides which are situated between the undulations are likewise situated at roughly the same point, such that thicker and thinner cross sections lie alongside one another in the longitudinal direction of the respective ribbon and this braiding part 3, which is configured as a ribbon, thus has a comparable or improved flexibility about its longitudinal axis compared to a braiding part 3 of such type formed by individual parallel and closely fitting wires or filaments.

Depending on the requirements, the braiding parts 3 of the sheathing 4 may be formed of metal or of plastic, wherein either all braiding parts 3 are formed of the same material or a mix of braiding parts 3 made of metal with those made of plastic may be provided. Plastic-coated or plastic-sheathed ribbons could also be provided as braiding parts 3.

The sanitary hose 1 has an inner hose 2 and a braided sheathing 4, made of mutually intersecting braiding parts 3, which encloses the inner hose 2. At least one of the braiding parts 3 or preferably all braiding parts 3 are configured here as single-part ribbons which thus replace multi-part braiding parts of such type formed by individual closely fitting wires or filaments. Here, the width of this ribbon is greater than its thickness and the wide side of these braiding parts 3 faces toward the inner hose 2. The peripheries 3a of these ribbon-shaped braiding parts 3 have a tapered cross section, such that said peripheries 3a extend tapering toward the outside and as a result permit an improved adaptation of intersecting braiding parts 3 even at the intersecting points 5.

1. A sanitary hose (1) comprising an inner hose (2), a braided sheathing (4) made of mutually intersecting braiding parts (3) which encases the inner hose (2), at least one of the braiding parts (3) is configured as a single-part ribbon, a width of which is greater than a thickness thereof, and a wide side of which faces toward the inner hose (2).

2. The sanitary hose according to claim 1, wherein each of the braiding parts (3), which in the use position are mutually interlaced and mutually intersecting, are configured as the single-part ribbons.

3. The sanitary hose according to claim 1, wherein a cross-sectional thickness of the single-part ribbon forming the at least one of the braiding parts (3) decreases at at least one periphery as a taper, in a stepped or continuous manner, as seen in cross-section.

4. The sanitary hose according to claim 3, wherein the taper at the periphery (3a) of the ribbon is symmetrical to a longitudinal center which is located between wide sides of the ribbon.

5. The sanitary hose according to claim 3, wherein both of the peripheries (3a) of the ribbon include the taper.

6. The sanitary hose according to claim 5, wherein the tapers at the peripheries (3a) of the ribbon are symmetrical to at least one of a longitudinal center which is located between wide sides of the ribbon or to a center running between the peripheries (3a).

7. The sanitary hose according to claim 3, wherein an end of a cross section of the taper of the periphery (3a) is pointed or rounded.

8. The sanitary hose according to claim 3, wherein a cross section of the taper at the periphery (3a) of the ribbon is delimited in a linear manner

9. The sanitary hose according to claim 3, wherein a cross section of the taper at the periphery (3a) of the ribbon is delimited at least one side in a convex or concave shape.

10. The sanitary hose according to claim 3, wherein an angle which is formed by surfaces delimiting the taper is an acute angle or a relatively smaller angle between 90° to 20°.

11. The sanitary hose according to claim 5, wherein a cross-sectional thickness of the ribbon between the tapers is approximately one tenth of a millimeter to two fifths of a millimeter.

12. The sanitary hose according to claim 1, wherein a width of the ribbon is five times to twenty times as large as a thickness thereof.

13. The sanitary hose according to claim 1, wherein wide sides of the ribbon are linear or undulated between peripheries (3a) thereof, as seen in cross-section.

14. The sanitary hose according to claim 13, wherein a cross section of the single-part ribbon is formed of neighboring alternately thicker and thinner regions.

15. The sanitary hose according to claim 1, wherein the braiding parts (3) of the sheathing (4) are formed of at least one of metal or plastic.

16. The sanitary hose according to claim 15, wherein all of the braiding parts (3) of the sheathing (4) are formed of the same material.

17. The sanitary hose according to claim 15, wherein a mix of braiding parts (3) made of metal and of plastic is provided for formation of the sheathing (4).

18. The sanitary hose according to claim 1, wherein the inner hose (2) is formed of plastic.
